(19) United States
(12) Patent Application Publication
(10) Pub. No.: US 2018/0127133 A1
(43) Pub. Date: May 10, 2018

(54) ADJUSTABLE SEALING HEAD FOR A FOIL SEALING DEVICE

(71) Applicant: Illinois Tool Works Inc., Glenview, IL (US)

(72) Inventors: Bradley J. Budde, North Prairie, WI (US); Robert A. Kleinschmidt, Hartford, WI (US); Timothy J. Handler, Menomonee Falls, WI (US)

(21) Appl. No.: 15/344,108

(22) Filed: Nov. 4, 2016

(51) Int. Cl. B65B 51/22; B65B 7/28; B29C 65/02; B29C 65/48

(52) U.S. Cl. CPC B65B 51/227; B65B 7/2878; B29L 2031/26; B29C 65/48; B29C 65/02

(57) ABSTRACT

According to an aspect of the present disclosure, an adjustable induction foil sealing device is used to hermetically seal a container. The device can be adjusted to accommodate differently sized containers. The device includes a power supply cabinet, first and second rail assemblies and an adjustment assembly coupling the rail assemblies together and coupling the rail assemblies to the cabinet. Each rail assembly has an induction sealing coil and conductive contacts. The contacts on the rail assemblies are in electrical contact with the contacts on the cabinet. The adjustment assembly is configured to adjust the relative positions of the rail assemblies relative to each other and relative to the cabinet, while maintaining the electrical connection of the contacts.

### FIELD OF THE INVENTION

The present invention relates generally to an adjustable sealing head for a foil sealing device which is used to hermetically seal a container.

### BACKGROUND

Prior art induction foil sealing devices are mounted over a conveyor line that transports containers for sealing. The containers may be used to store products, such as food, pharmaceuticals, beverages, and chemicals. Each container is filled and provided with a cap containing a foil disk or “cap seal.” The capped containers are passed under the induction foil sealing device, which utilizes an induction sealing coil. The induction sealing coil indirectly heats the foil by induction, thereby melting sealant supplied with the foil. As the sealant cools, the foil is adhered to the container to seal the container.

### SUMMARY

In one aspect, an adjustable sealing head is provided which, when connected to a power supply cabinet, is used to hermetically seal a container. The sealing head can be adjusted to accommodate differently sized containers. The sealing head includes an upper housing, first and second rail assemblies connected to the housing, an induction sealing coil extending through the housing and the rail assemblies, and an adjustment assembly coupling the rail assemblies together and coupling the rail assemblies to the upper housing. The adjustment assembly is configured to adjust the relative positions of the rail assemblies relative to each other and relative to the housing.

The scope of the present invention is defined solely by the appended claims and is not affected by the statements within this summary.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a side elevation view of an adjustable induction foil sealing device;

FIG. 2 depicts a bottom perspective view of a power supply cabinet of the prior art;

FIG. 3 depicts a front perspective view of an adjustable sealing head of the adjustable induction foil sealing device and an associated conveyor;

FIG. 4 depicts a rear perspective view of the adjustable sealing head;

FIG. 5 depicts a side elevation view of the adjustable sealing head;

FIG. 6 depicts a top plan view of the adjustable sealing head;

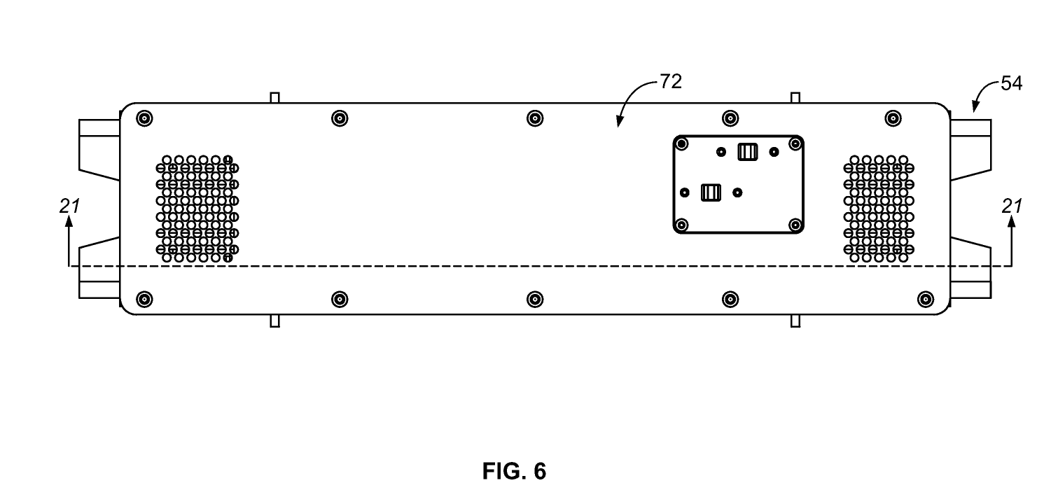

FIG. 7 depicts a perspective view of a prior art associated container and its cap;

FIG. 8 depicts a bottom perspective view of an upper housing which forms part of the adjustable sealing head;

FIG. 9 depicts a top perspective view of a pair of rail assemblies and an adjustment assembly which form parts of the adjustable sealing head;

FIG. 10 depicts a top plan view of the rail assemblies and the adjustment assembly;

FIG. 11 depicts a perspective view of a rail of the sealing head viewed from an outer side of the rail;

FIG. 12 depicts a side elevation view of the rail viewed from the outer side of the rail;

FIG. 13 depicts a front elevation view of the rail;

FIG. 14 depicts a perspective view of a cover of the sealing head viewed from an outer side of the cover;

FIG. 15 depicts a top perspective view of the adjustment assembly;

FIG. 16 depicts a front elevation view of an adjustment screw which forms part of the adjustment assembly;

FIG. 17 depicts a front end elevation view of the adjustable sealing head;

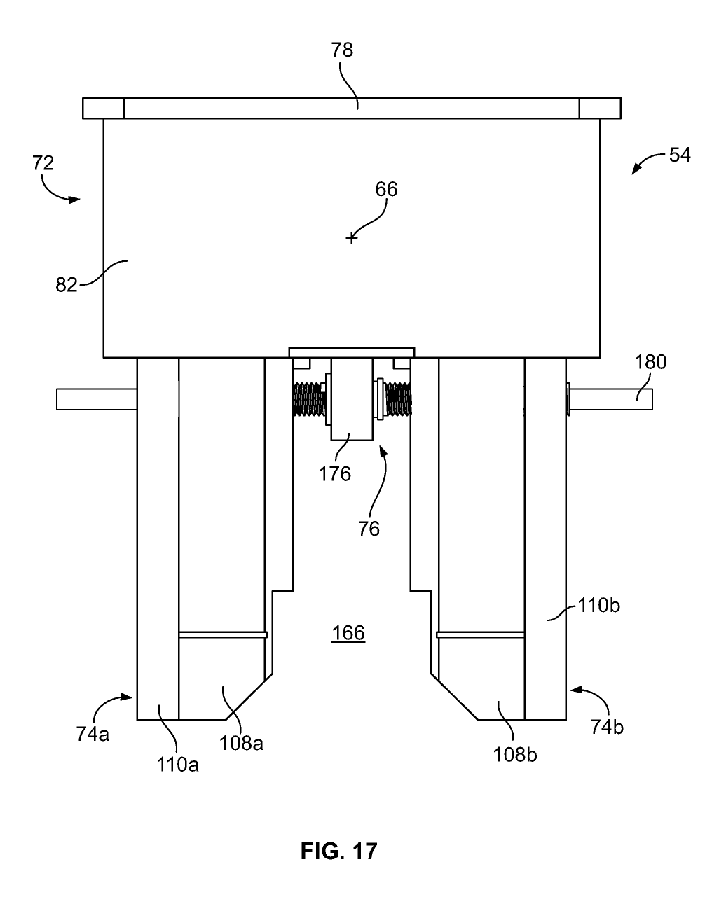

FIG. 18 depicts a cross-sectional view of the adjustable sealing head along line 18-18 of FIG. 5;

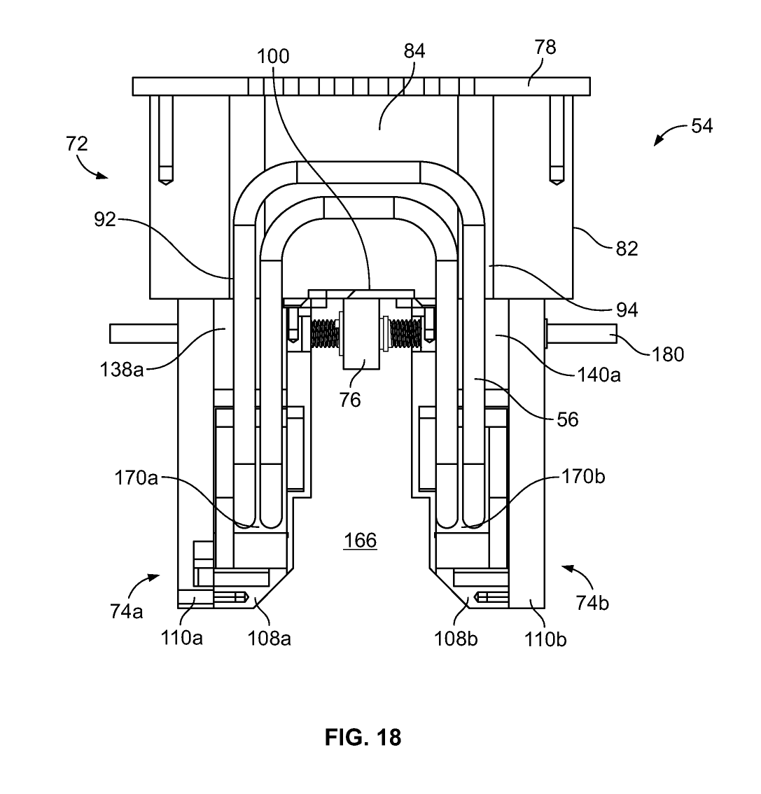

FIG. 19 depicts a cross-sectional view of the adjustable sealing head along line 19-19 of FIG. 5;

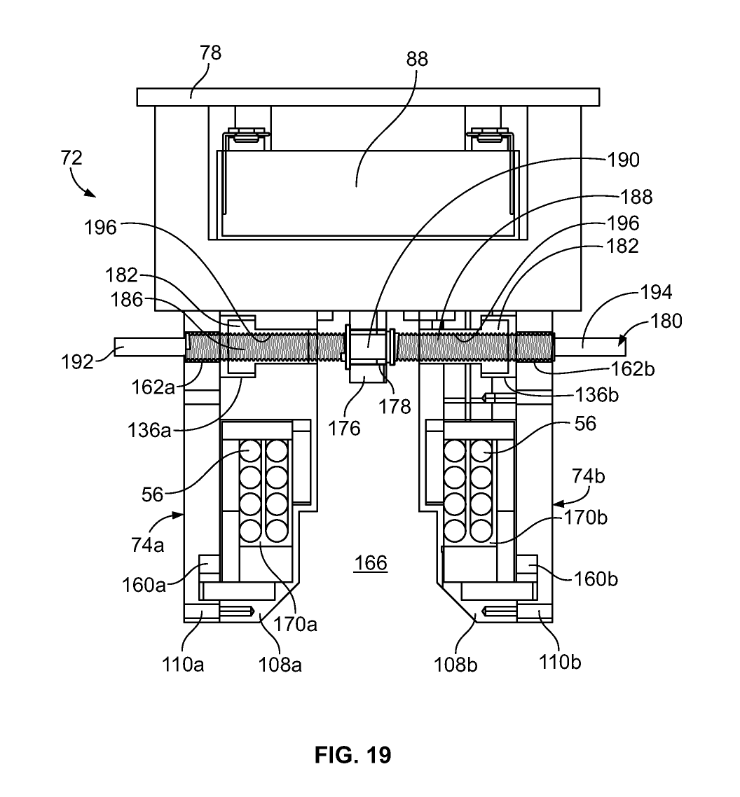

FIG. 20 depicts a cross-sectional view of the adjustable sealing head along line 20-20 of FIG. 5;

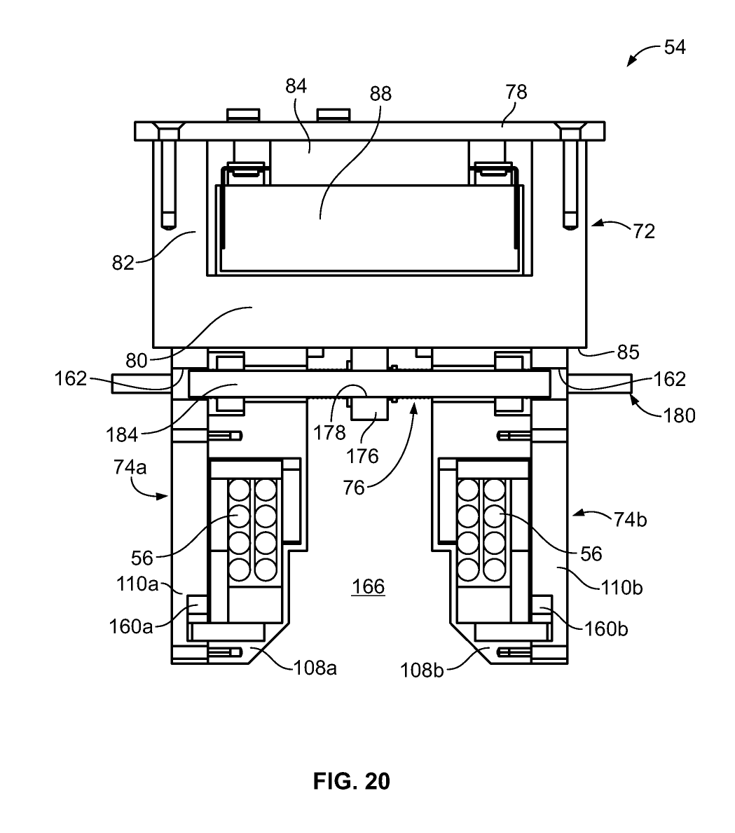

FIG. 21 depicts a cross-sectional view of the adjustable sealing head along line 21-21 of FIG. 6; and

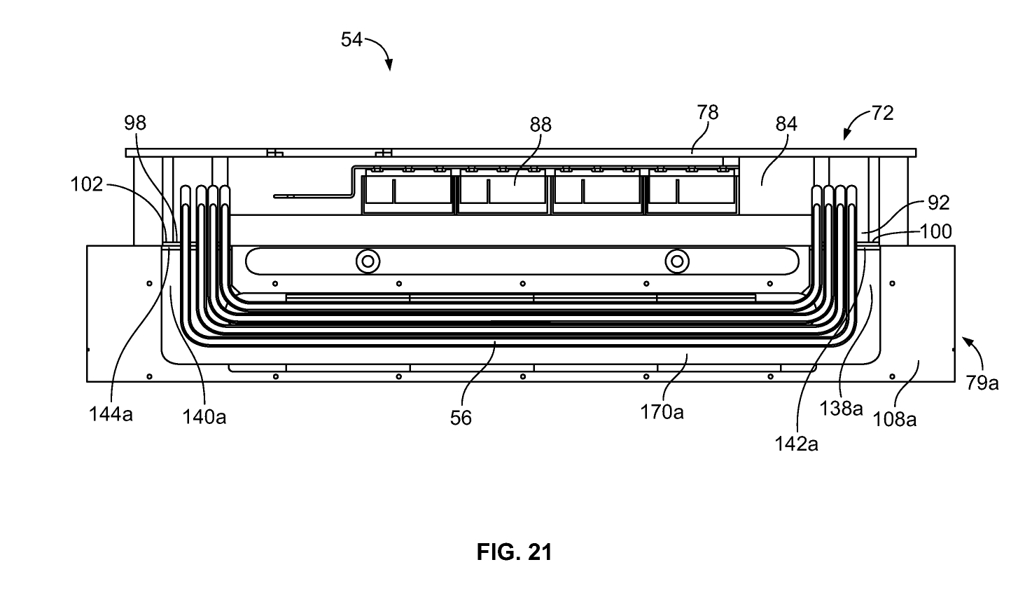

FIG. 22 depicts a front perspective view of an alternate adjustable sealing head.

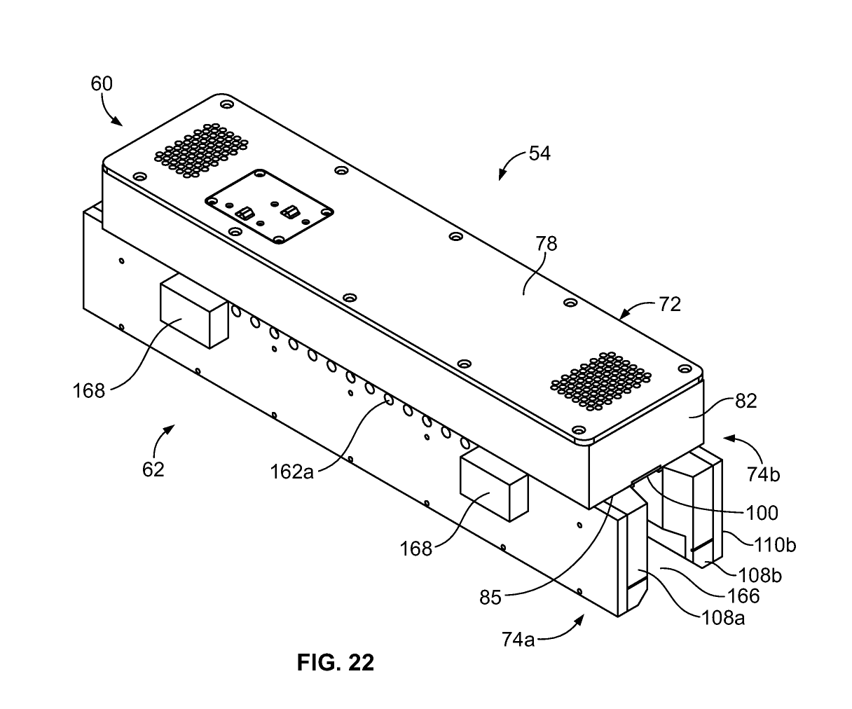

### DETAILED DESCRIPTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein. Therefore, unless otherwise noted, features disclosed herein may be combined together to form additional combinations that were not otherwise shown for purposes of brevity.

An adjustable induction foil sealing device 20 is provided to hermetically seal a container 22. The container 22 is filled and provided with a cap 24 containing a foil disk 26 or “cap seal.” The capped containers 22 are passed through the induction foil sealing device 20 which indirectly heats the foil disk 26 by induction, thereby melting sealant supplied with the foil disk 26. As the sealant cools, the foil disk 26 is adhered to the container 22 to seal the container 22. In an embodiment, the cap 24 has a diameter of 1 inch to 2 and ¼ inches. In an embodiment, the cap 24 has a diameter of 2 and ¼ inches to 3 and ½ inches. The diameter of the cap 24 may be larger or smaller.

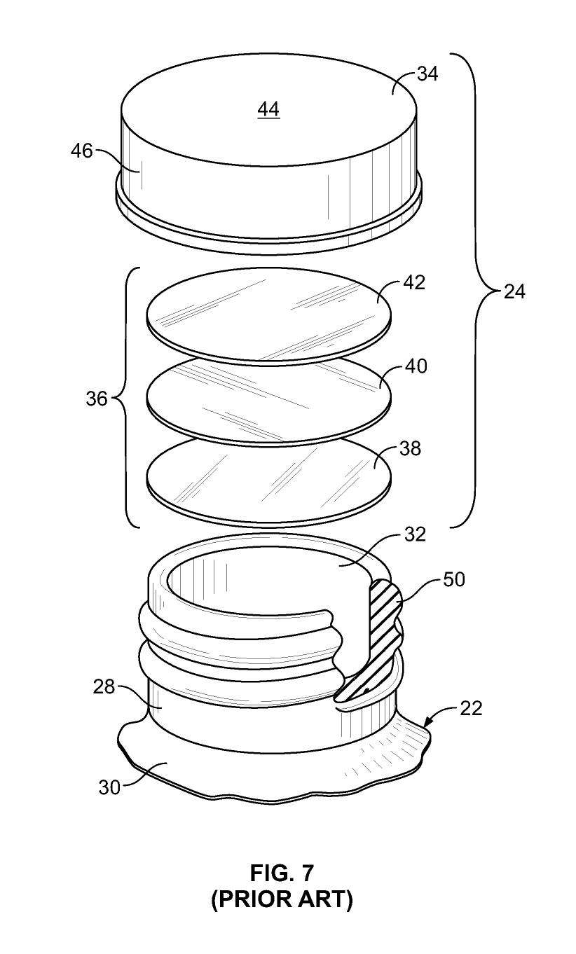

Such a container 22 and cap 24 are disclosed in U.S. Pat. No. 2,937,481 as shown in FIG. 7. The container 22 includes a neck portion 28 joined to the body 30 of the container 22. The neck portion 28 has an opening 32 in its upper end to allow the container 22 to be filled.

The cap 24 is formed of an outer housing 34 in which a multi-layer gasket 36 is mounted. The gasket 36 may be circular in configuration and of a diameter approximately equal to the outer diameter of the neck portion 28. The gasket 36 includes a thin circular sheet or diaphragm 38 of a synthetic organic thermoplastic material which is compatible and fusible with the material forming container 22. The diaphragm 38 should be of a frangible nature and preferably formed of the same material as container 22, for example polyethylene, and may be formed of other materials such as vinyl chloride, vinylidene chloride and polyesters such as polyethylene per phthalate. Superimposed upon diaphragm 38 is a thin metallic, intermediate circular disc 40 preferably formed of aluminum or similar metal, and in heat transfer relationship with the diaphragm 38. A cushioning member 42, also in the form of a circular disc, is superimposed upon the metal disc 40 and is formed of a suitably resilient material such as paper or the like. Diaphragm 28 and discs 40 and 42 may be permanently or temporarily secured to each other by any suitable adhesive.

The housing 34 is a non-metallic material, such as a thermoset organic plastic material, and of conventional construction, including a top wall 44 and a depending peripheral collar 46. A thread (not shown) may be provided on the inner face of the collar 46 which mates with a thread 50 on the neck portion 28 of the container 22. The gasket 36 nests in the housing 34 and the cushioning member 42 abuts the underface of the top wall 44.

The adjustable induction foil sealing device 20 is used to affect a hermetic seal between the gasket 36 and the opening 32 into the container 22.

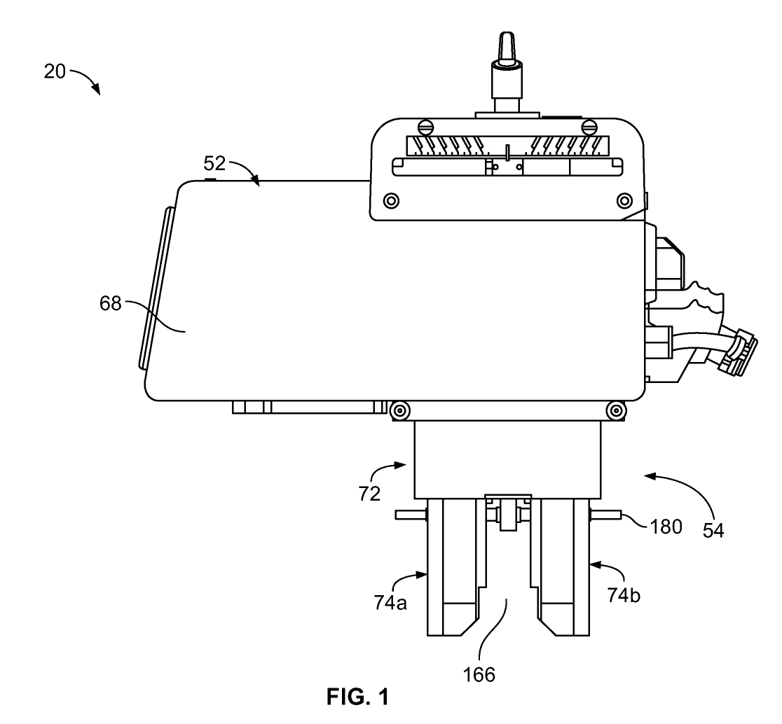

As shown in FIG. 1, the adjustable induction foil sealing device 20 includes a power supply cabinet 52 operatively connected with a sealing head 54 which houses an induction sealing coil 56 which generates a zone of high intensity magnetic field. A front end of the sealing head 54 is defined at reference numeral 58, and a rear end of the sealing head 54 is defined at reference numeral 60; as such, reference numeral 62 denotes a left side of the sealing head 54 and reference numeral 64 denotes a right side of the sealing head 54 when the adjustable induction foil sealing device 20 is viewed from the front end 58 thereof. A centerline 66 of the sealing head 54 is defined between the front and rear ends 58, 60.

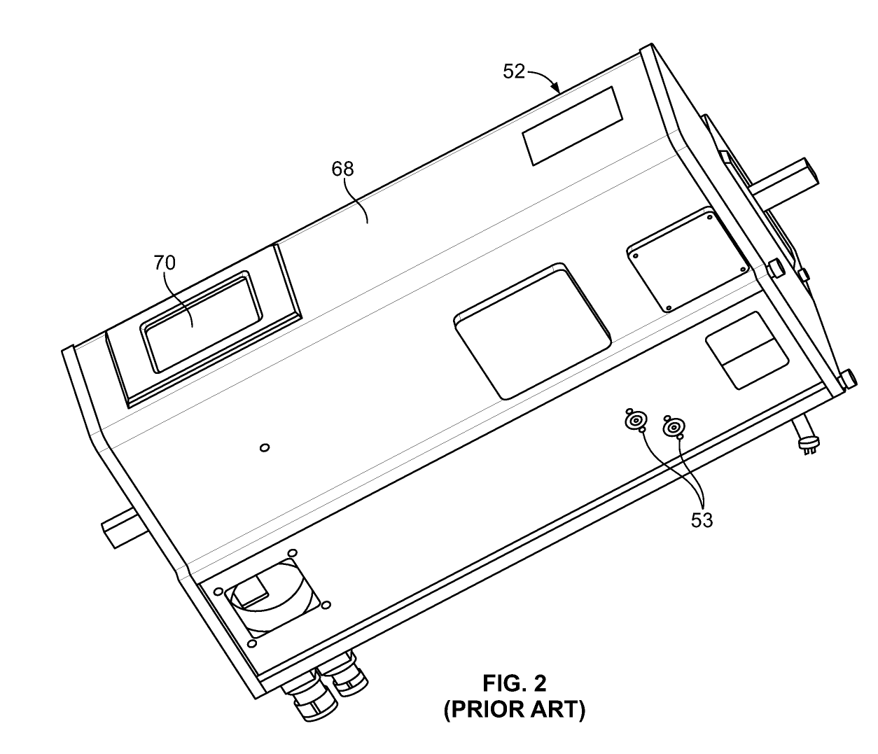

Such a power supply cabinet 52 is disclosed in U.S. Pat. No. 9,216,542 and is shown in FIG. 2. The power supply cabinet 52 may include a housing 68 including a display 70, which in an embodiment is a touch screen, configured to allow an operator to program and control the adjustable induction foil sealing device 20. Other inputs may be used, such as keypads or the like, or the adjustable induction foil sealing device 20 may be externally controlled by, for example, a computer over a direct coupling or network connection. The power supply cabinet 52 houses a power module therein that preferably receives an alternating current (A/C) input of 240 volts (V) at 50-60 Hertz (Hz). The power module provides an output to the sealing head 54 which varies in output voltage and frequency, depending on the foil load, in a conventional manner. The power supply cabinet 52 includes a pair of electrical contacts 53 as is known in the art.

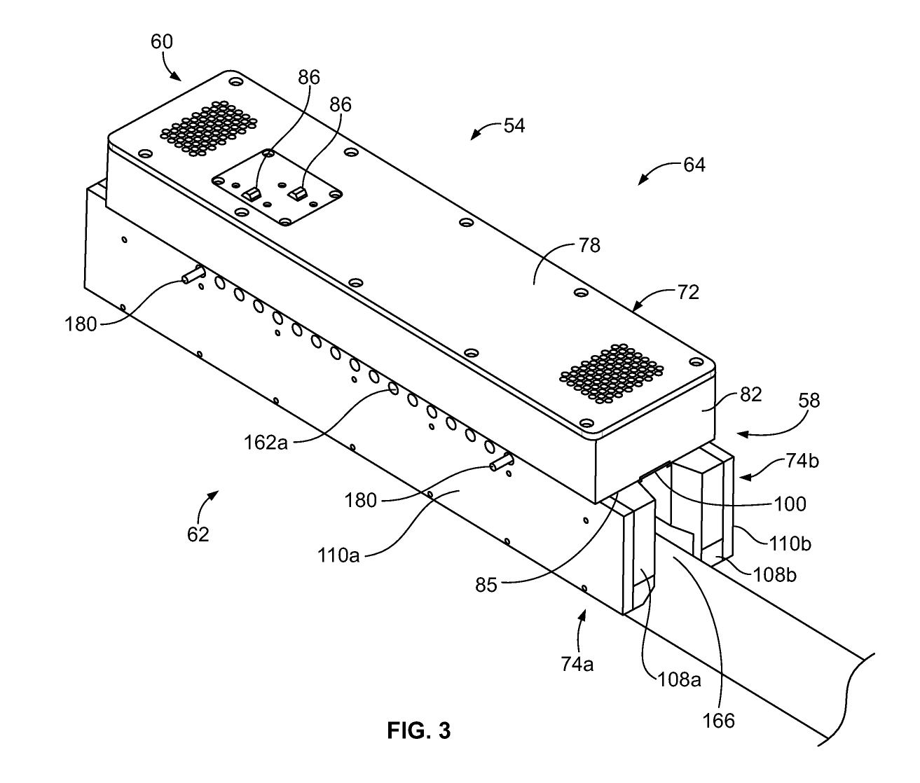

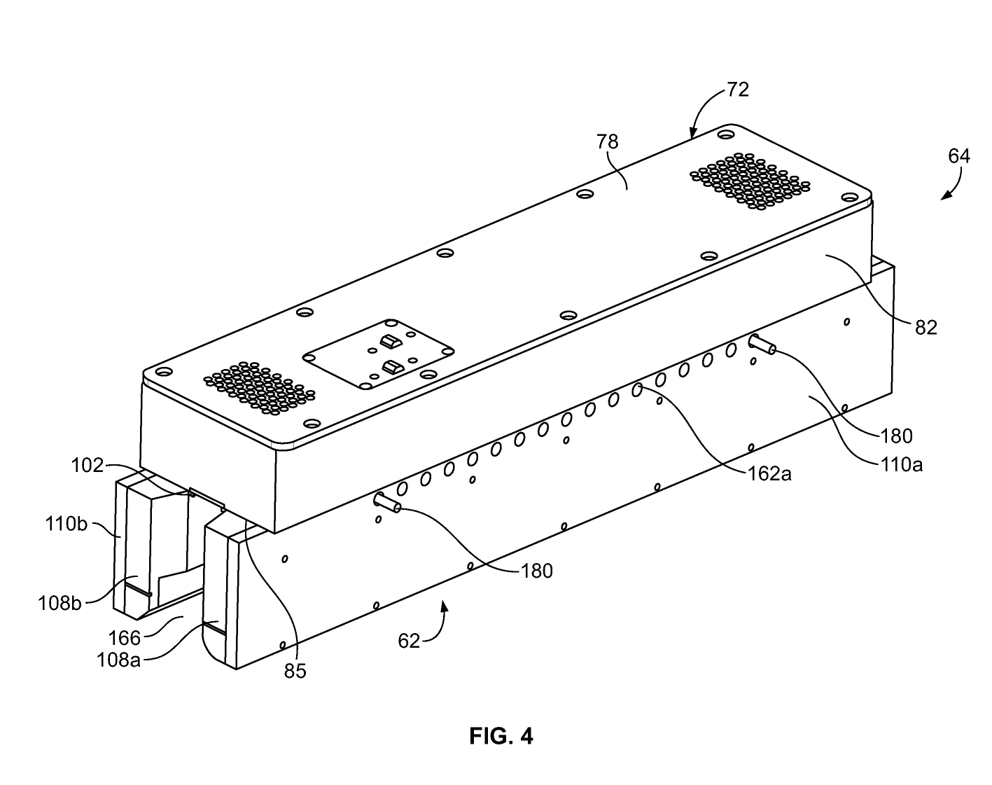

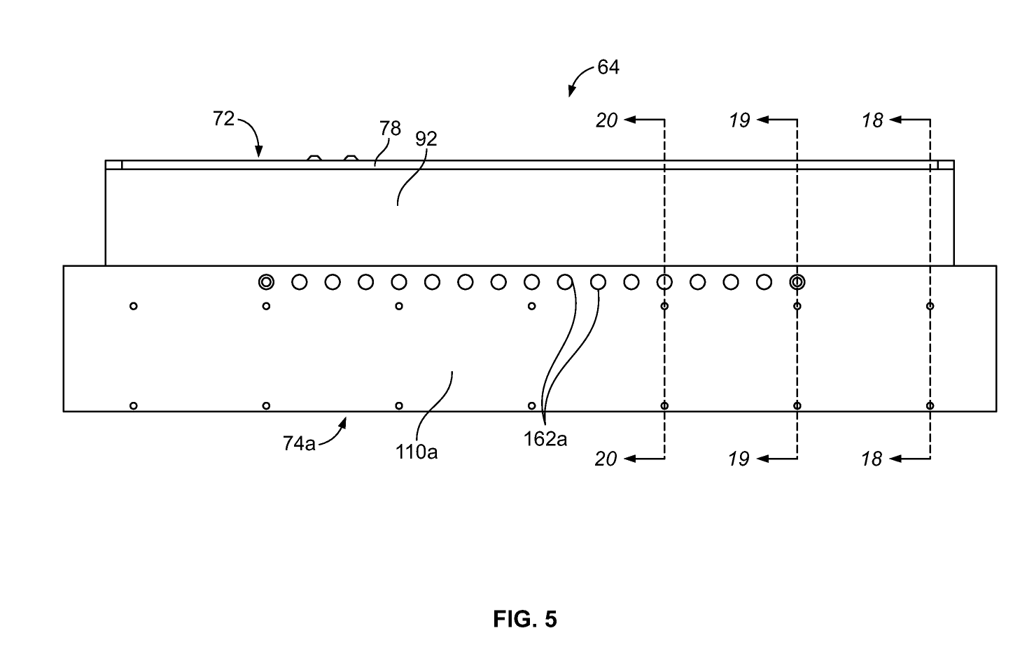

As shown in FIGS. 3-5, the sealing head 54 includes an upper housing 72 which is electrically connected to the power supply cabinet 52, a first or left side rail assembly 74a, and a second or right side rail assembly 74b, and an adjustment assembly 76. The adjustment assembly 76 couples the left and right side rail assemblies 74a, 74b to each other, couples the left and right side rail assemblies 74a, 74b to the upper housing 72, and allows the left and right side rail assemblies 74a, 74b to move relative to each other and to move relative to the upper housing and thus relative to the power supply cabinet 52.

The upper housing 72 includes a top wall 78, a bottom wall 80 and upstanding side walls 82 which forms a cavity 84 therein. Each of the walls 78, 80, 82 are non-conductive and, in an embodiment, are formed plastic or other non-metallic material. In an embodiment, the top wall 78 is formed as a separate component and attached to the side walls 82. A pair of electrical contacts 86 extend through the top wall 78 and are in electrical communication with the power supply cabinet 52 and with electrical components 88 which are provided within the cavity 84.

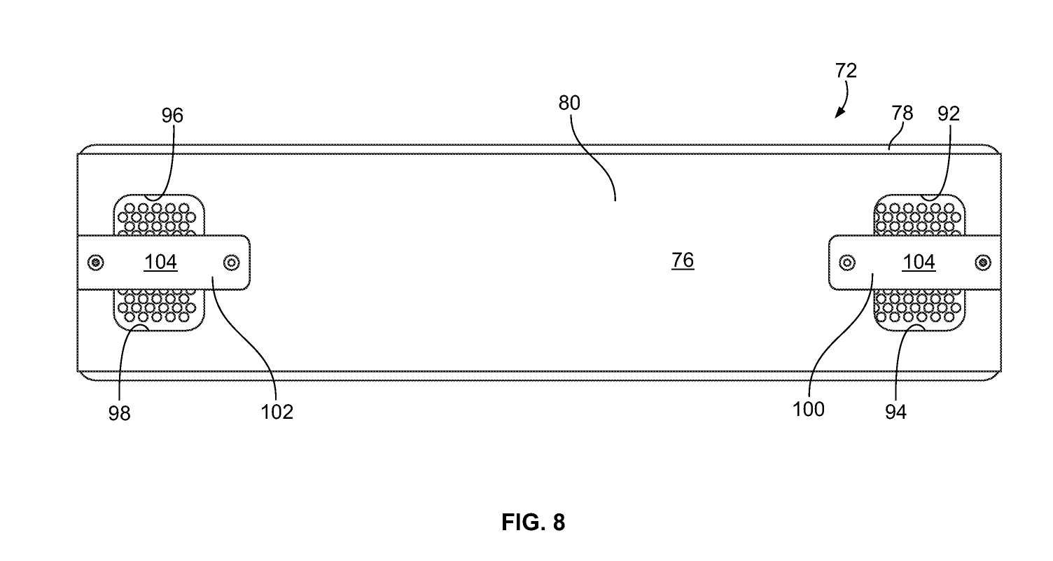

The bottom wall 80 has a planar lower surface 85. As shown in FIG. 8, first and second pairs of openings 92, 94 and 96, 98 are provided through the bottom wall 80 and are in communication with the cavity 84. The first pair of openings 92, 94 are proximate to the front end 58 of the sealing head 54 and are separated from each other by a wall portion 100. The second pair of openings 96, 98 are proximate to the rear end 60 of the sealing head 54 and are separated from each other by a wall portion 102. Each wall portion 100, 102 has an upper surface and an opposite planar lower surface 104 which is coplanar with the planar lower surface 85 of the remainder of the bottom wall 80. In an embodiment, the pairs of openings 92, 94 and 96, 98 are each provided by a single opening and the wall portions 100, 102 are non-conductive covers fastened to the bottom wall 80, which bifurcate each opening into two openings, and which seat within front and rear recesses formed in the bottom wall 80 such that the lower surfaces 85, 104 are flush with each other.

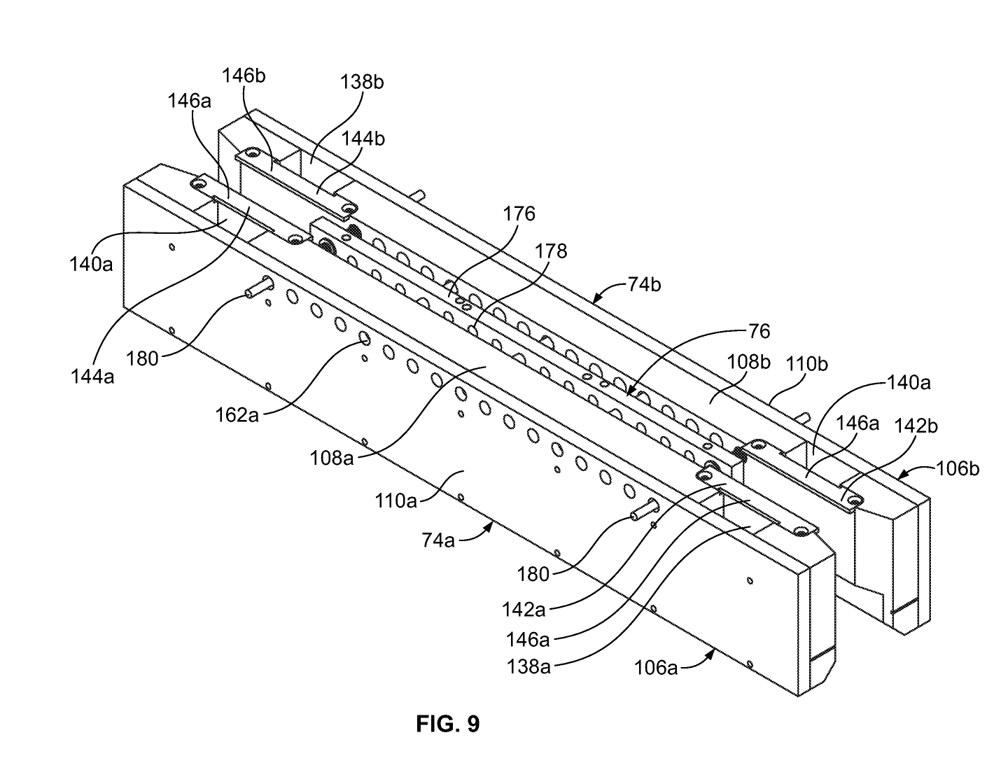

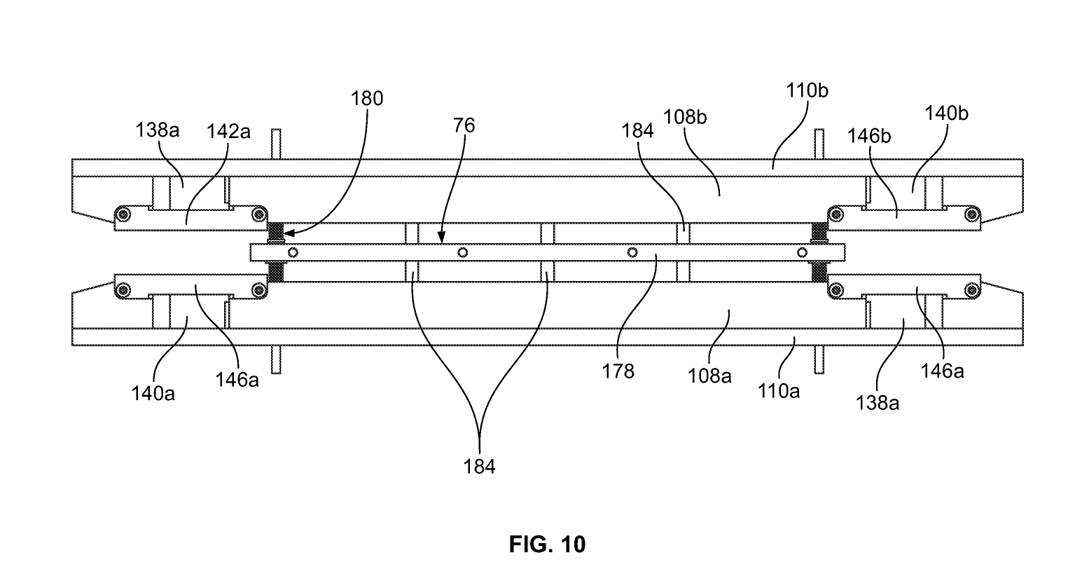

As shown in FIGS. 9 and 10, each side rail assembly 74a, 74b includes a housing 106a, 106b formed of a rail 108a, 108b and a cover 110a, 110b mounted on the rail 108a, 108b. The housings 106a, 106b form first and second lower housings which are mounted below the upper housing 72. The rails 108a, 108b and the covers 110a, 110b are formed from non-conductive materials, such as plastic or other non-metallic material.

The components of the left side rail assembly 74a are described with the understanding that the components of the right side rail assembly 74b are identically formed. The components of the left side rail assembly 74a are labeled with the suffix “a” and the components of the right side rail assembly 74b are labeled with the suffix “b”.

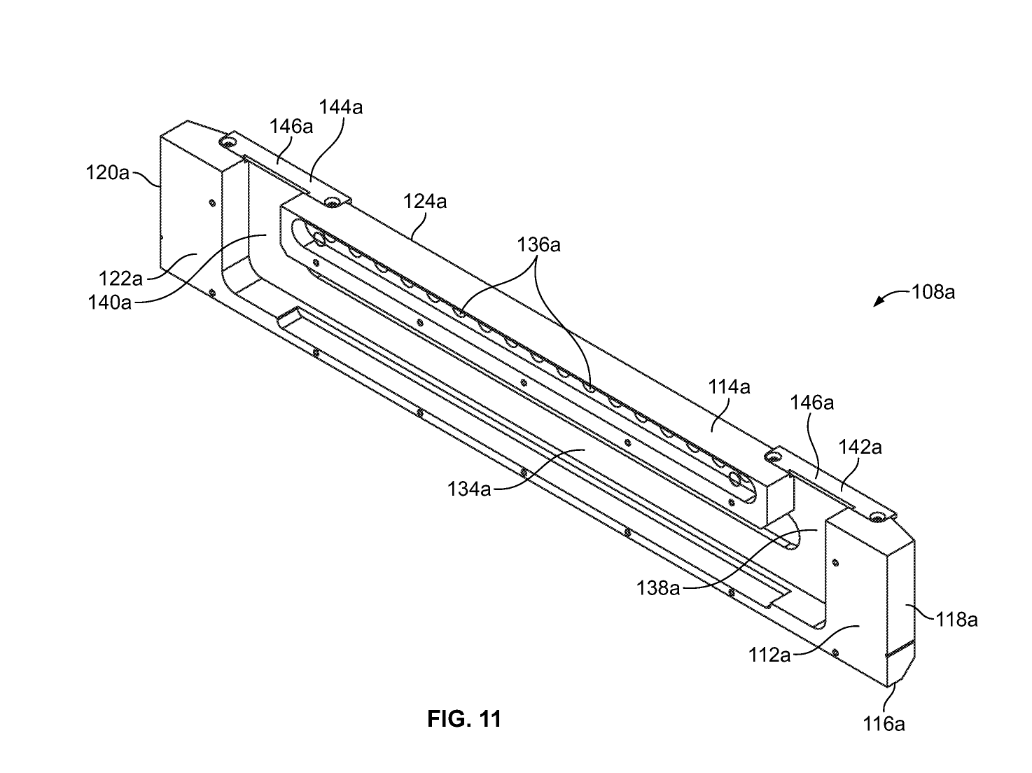

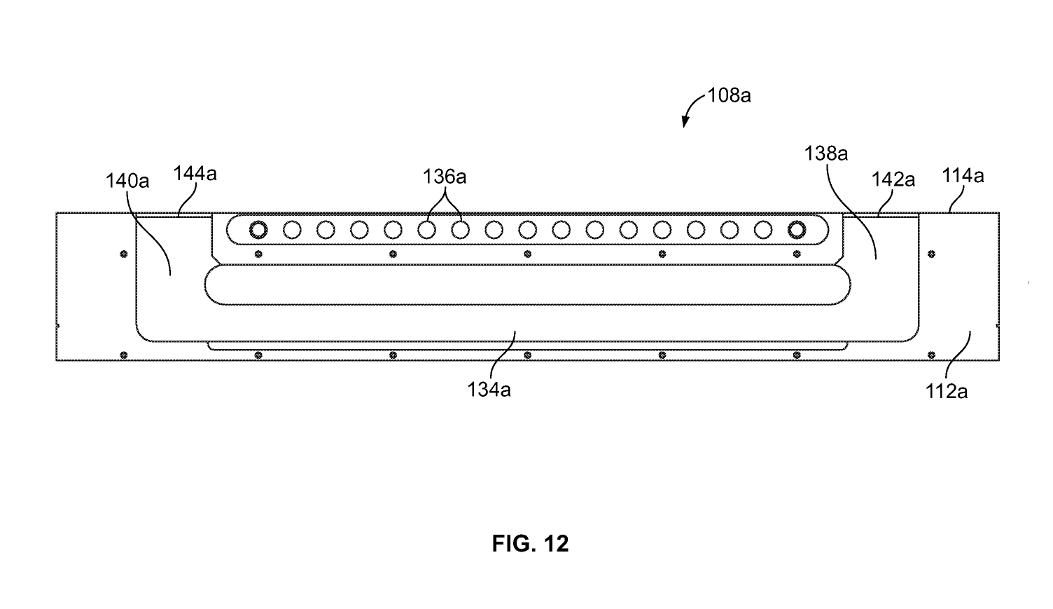

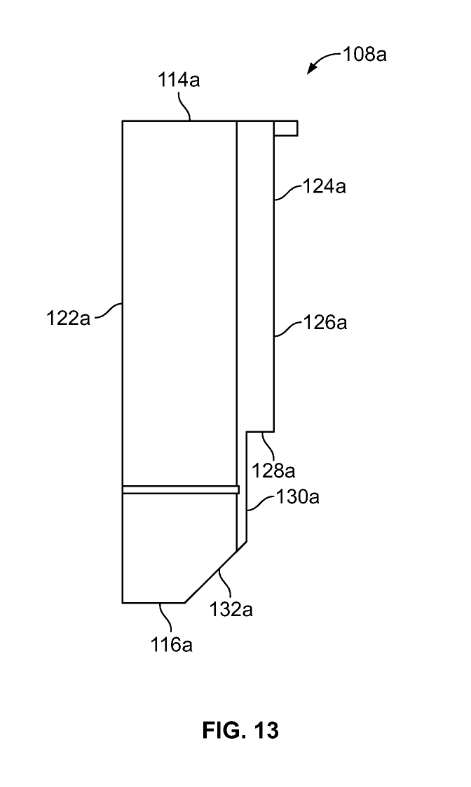

As shown in FIGS. 11-13, the rail 108a is formed of a wall 112a having a planar upper surface 114a, a lower surface 116a, front and rear surfaces 118a, 120a extending between the upper and lower surfaces 114a, 116a, and outer and inner surfaces 122a, 124a extending between the surfaces 114a, 116a, 118a, 120a. The inner surface 124a is shaped to accommodate the shape of the container 22. In an embodiment, as shown in FIG. 13, the inner surface 124a has an upper vertical surface section 126a which extends from the upper surface 114a downwardly, a first intermediate horizontal surface section 128a which extends perpendicularly from the lower end of the upper vertical surface section 126a, as second intermediate vertical surface section 130a which extends perpendicularly from the outer end of the first intermediate horizontal surface 128a section such that the second intermediate vertical section 130a is offset from the upper vertical surface section 126a, and a lower angled surface section 132a which extends at an angle outwardly from the lower end of the second intermediate vertical surface section 130a to the lower surface. In an embodiment, the lower angled surface section 132a is angled at 45 degrees from vertical. Other shapes of the inner surface 124a may be provided. The outer surface 122a has a recess 134a formed therein which is proximate to, but spaced from the lower surface 116a, and extends partially between the front and rear surfaces 118a, 120a. A plurality of through holes 136a are provided through the rail 108a proximate to, but spaced from, the upper surface 114a, and extend from the outer surface 122a to the inner surface 124a. The through holes 136a are linearly aligned. A front recess 138a extends from the upper surface 114a to the recess 140a and is proximate to, but spaced from, the front surface 118a. A rear recess 140a extends from the upper surface 114a to the recess 140a and is proximate to the rear surface 120a. In an embodiment, a front wall portion 142a seats within a forward recess which is proximate to the front recess 138a, and a rear wall portion 144a seats within a rearward recess which is proximate to the rear recess 140a. Each wall portion 142a, 144a has a planar upper surface 146a and seats within the respective recesses such that the upper surfaces 146a of the wall portions 142a, 144a are coplanar with the upper surface 114a of the rail 108a. In an embodiment, the wall portions 142a, 144a are fastened to the rail 108a. The wall portions 142a, 144a may be integrally formed as part of the wall 112a.

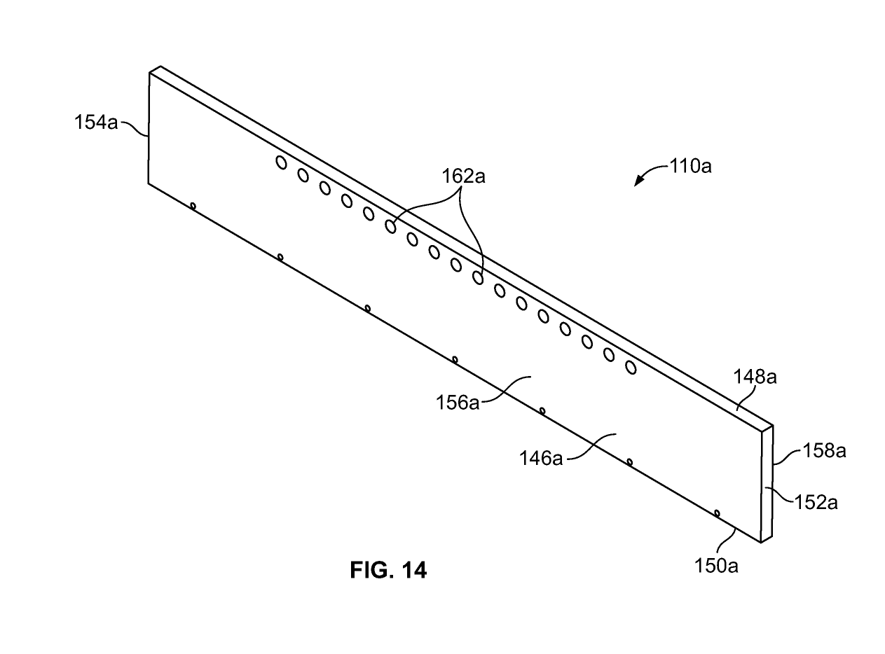

As shown in FIG. 14, the cover 110a is formed of a plate 146a having an upper surface 148a, a lower surface 150a, front and rear surfaces 152a, 154a extending between the upper and lower surfaces 148a, 150a, and an outer surface 156a and a planar inner surface 158a extending between the surfaces 148a, 150a, 152a, 154a. The inner surface 158a has a recess 160a formed therein which is proximate to, but spaced from the lower surface 150a, and extends between the front and rear surfaces 152a, 154a. A plurality of through holes 162a are provided through the cover 110a proximate to, but spaced from, the upper surface 148a, and extend from the outer surface 156a to the inner surface 158. The through holes 162a are linearly aligned.

When assembled, the outer surface 122a of the rail 108a engages against the inner surface 158a of the cover 110a and the recesses 134a, 160a are adjacent to each other to form a cavity 170a which also includes recesses 138a, 140a. The through holes 136a in the rail 108a align with the through holes 162a in the cover 110a.

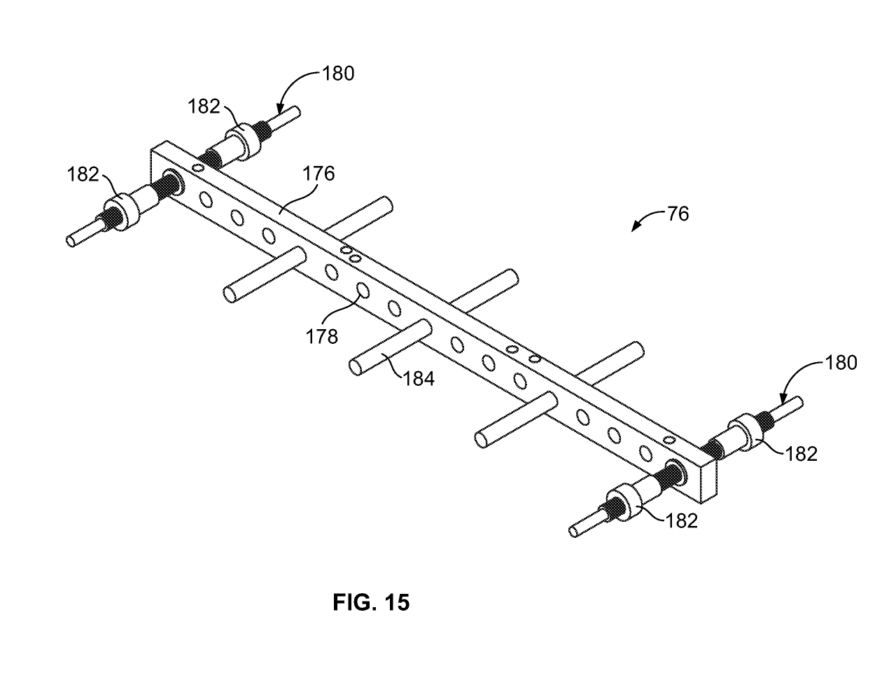

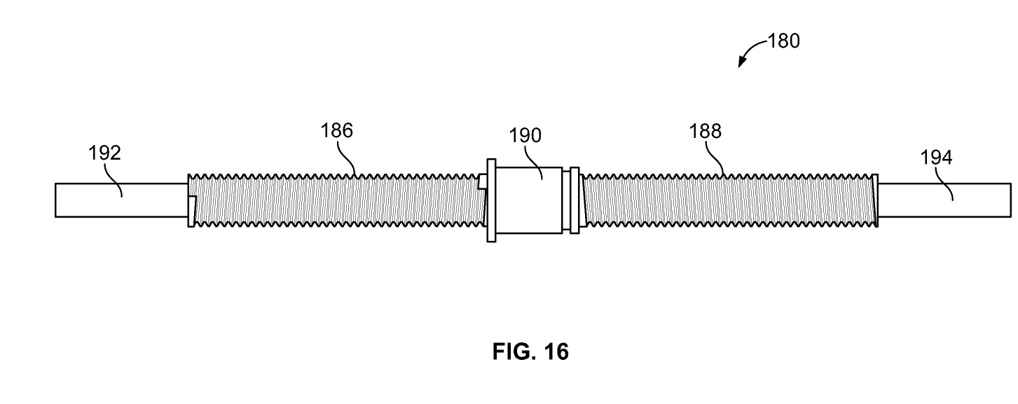

Referring to FIGS. 15 and 16, the adjustment assembly 76 includes an elongated mounting bar 176 which has a plurality of spaced apart unthreaded through holes 178 which are linearly aligned along the length of the mounting bar 176. The mounting bar 176 is affixed to the planar bottom surface 85 of the upper housing 72. The mounting bar 176 extends generally from the front end 58 of the housing 72 to the rear end 60 of the housing 72 and may be positioned along the centerline 66 of the housing 72. The mounting bar 176 is positioned between the rails 74a, 74b. When assembled, the through holes 178 in the mounting bar 176 align with the through holes 136a, 136b in the rails 108a, 108b and with the through holes 162a, 162b in the covers 110a, 110b.

The adjustment assembly 76 further includes first and second adjustment screws 180, a pair of bushings 182 for each adjustment screw 180, and may include a plurality of slide pins 184.

As shown in FIG. 16, each adjustment screw 180 has a left hand threaded portion 186 and a right hand threaded portion 188 which are separated from each other by an unthreaded portion 190. In an embodiment, the unthreaded portion 190 is provided at the center of the respective adjustment screw 180. Each adjustment screw 180 further includes unthreaded end portion 192 at the end of the left hand threaded portion 186 and an unthreaded end portion 194 at the end of the right hand threaded portion 188.

A first pair of the bushings 182 are mounted within aligned through holes 136a, 136b in the rails 108a, 108b. A second pair of the bushings 182 are mounted within aligned through holes 136a, 136b in the rails 108a, 108b at a spaced apart position from the first pair. The bushings 182 are affixed to the rails 108a, 108b such that the bushings 182 do not rotate relative to the rails 108a, 108b. Each bushing 182 has a central threaded passageway 196 therethrough.

The rail assemblies 74a, 74b are mounted to the upper housing 72 by the adjustment assembly 76. For each adjustment screw 180, the unthreaded left end portion 192 extends through the through hole 162a in the left cover 110a and outwardly therefrom. For each adjustment screw 180, the left hand threaded portion 186 extends through the through hole 136a in the left rail 108a and through the threaded passageway 196 of the left bushing 182. For each adjustment screw 180, the unthreaded central portion 190 extends through the through hole 178 in the mounting bar 176. Each adjustment screw 180 is attached to the mounting bar 176 such that each adjustment screw 180 is rotatable relative to the mounting bar 176, but cannot linearly translate relative to the mounting bar 176. For each adjustment screw 180, the right hand threaded portion 188 extends through the threaded passageway 196 of the right bushing 182 and through the through hole 136a in the left rail 108b. For each adjustment screw 180, the unthreaded right end portion 194 extends through the through hole 162a in the right cover 110b and outwardly therefrom. The left hand threaded portions 186 of the adjustment screws 180 are threadedly engaged with the bushings 182 affixed to the left rail 108a, and the right hand threaded portions 188 of the adjustment screws 180 are threadedly engaged with the bushings 182 affixed to the right rail 108b. When the rail assemblies 74a, 74b are attached to the upper housing 72 by the adjustment assembly 76, a gap 166 is formed between the inner surfaces 124a, 124b of the rails 108a, 108b.

The upper surfaces 146a, 146b of the front wall portions 142a, 142b on the left and right rails 108a, 108b are engaged with the planar lower surface 85 of the wall portion 100 of the upper housing 72. The upper surfaces 146a, 146b of the rear wall portions 144a, 144b on the left and right rails 108a, 108b are engaged with the lower surface 85 of the rear wall 102 on the housing 72 of the upper housing 72.

Each slide pin 184 extends partially through one of the through holes 162a in the left cover 110a, through the aligned through hole 136a in the left rail 108a, through the aligned through hole 178 in the mounting bar 176, through the aligned through hole 136b in the right rail 108b, and partially through the through hole 162b in the right cover 110a.

The induction sealing coil 56 may be constructed of a copper litz wire, although other types of conducting material may be used. A ferrite core (not shown) and resonant capacitors (not shown) are utilized with the induction sealing coil 56 in a conventional manner. The induction sealing coil 56 loops through the upper housing 72, through the first rail assembly 74a, through the upper housing 72, through the second rail assembly 74b, and repeats this routing to form a plurality of loops. More specifically, the induction sealing coil 56 extends from the cavity 84 in the upper housing 72, downwardly through the opening 92 in the upper housing 72, downwardly through the recess 138a in the first rail assembly 74a, through the cavity 170a in the first rail assembly 74a, upwardly through the recess 140a in the first rail assembly 74a, upwardly through the opening 98 in the upper housing 72, over the wall 102 and through the cavity 84 in the upper housing 72, downwardly through the opening 96 in the upper housing 72, downwardly through the passageway 138a in the second rail assembly 74b, through the cavity 170b in the second rail assembly 74b, upwardly through the passageway 140b in the second rail assembly 74b, upwardly through the opening 92 in the upper housing 72, and over the wall portion 100 in the upper housing 72. This loop repeats itself a predetermined number of times. In the part of the induction sealing coil 56 which is above the wall portions 100, 102, a predetermined amount of slack of the induction sealing coil 56 is provided. The electrical components 88 in the cavity 84 are in electrical communication with the induction sealing coil 56.

The size of the gap 166 between the left and right rail assemblies can be adjusted to be made wider or narrower by using the adjustment assembly 76. This enables the adjustable induction foil sealing device 20 to accommodate differently sized containers 22 between the rail assemblies 74a, 74b while properly positioning the induction sealing coil 56 relative to the container 22 to be sealed. When the adjustment screws 180 are rotated, this causes the bushings 182 to translate along the length of the respective threaded portion 186, 188, which, in turn, causes the rail assemblies 74a, 74b to slide and translate relative to the upper housing 72. The front walls 142a, 142b on the rail assemblies 74a, 74b slide relative to the front wall portion 100 on the housing 72, and the rear wall portions 144a, 144b on the rail assemblies 74a, 74b slide relative to the rear wall portion 102 on the housing 72. The slack in the induction sealing coil 56 is reduced when the rail assemblies 74a, 74b are moved further apart from each other; the slack in the induction sealing coil 56 is increased when the rail assemblies 74a, 74b are moved toward each other. This either widens or narrows the gap 166 between the rail assemblies 74a, 74b. The front and rear wall portions 100, 102 on the upper housing 72 are wide enough such that during this translation of the rail assemblies 74a, 74b relative to the upper housing 72, the front wall portions 112a, 112b on the rail assemblies 74a, 74b always maintain contact with the front wall portion 100 on the housing 72, and the rear wall portions 144a, 144b on the rail assemblies 74a, 74b always maintain contact with the rear wall portion 102 on the housing 72. This prevents entry of an object into the cavities 74, 170a, 170b. If the slide pins 184 are provided, the slide pins 184 may further support the rail assemblies 74a, 74b during this movement.

In an embodiment, the adjustment screws 180 are manually rotated by hand and do not require the use of tools to rotate them. In an embodiment, the unthreaded end portions 192, 194 have knobs (not shown) thereon. In an embodiment, motors 168 are used to rotate the adjustment screws 180. A control system (not shown) may be provided to operate the motors 168. In an embodiment, the motor 168 is hydraulically actuated. In an embodiment, the motor 168 is pneumatically actuated.

In an embodiment, rotation of the adjustment screws 180 causes both rail assemblies 74a, 74b to translate along the adjustment screws 180 and relative to the upper housing 72. In an embodiment, the adjustment screws 180 are formed of two or three parts (for example, one part includes 192/186/190 and the other part includes 188/194) which are mated together, such that the left part which has the left-hand thread 186 can rotate independently of the right part which has the right-hand thread 188 thereon. This allows for independent sliding translation of one of the rail assemblies 74a, 74b relative to the other rail assembly.

While two adjustment screws 180 are shown and described, a single adjustment screw 180 can be provided or more than two adjustment screws 180 can be provided. In addition, the slide pins 184 can be eliminated.

After the rail assemblies 74a, 74b have been positioned in the desired position to form the appropriate gap 166, a material to be packaged, such as a liquid, is introduced into the container 22 and the cap 24 carrying the gasket 36 is applied to the neck portion 28 of the container 22. Thereafter, the capped container 22 is placed on conveyor 202 and transported therealong so that the neck portion 28 of the container 22 passes between the rail assemblies 74a, 74b in the gap 166 and in the high frequency magnetic field generated by the induction sealing coil 56. As a result, metal disc 40 is heated by induction to a temperature sufficiently high to soften and melt the thermoplastic diaphragm 38 as well as the abutting section of the container 22. For example, an appropriate gap 166 provides approximately 1 mm between the rails 108a, 108b and the cap 24.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. An adjustable sealing head capable of being connected to power supply cabinet of an induction foil sealing device, comprising:
a non-conductive upper housing having conductive contacts mounted thereon capable of being connected to the power supply cabinet, the upper housing having a cavity formed therein;
a non-conductive first lower housing mounted below the upper housing, the first lower housing having a cavity formed therein;
a non-conductive second lower housing mounted below the upper housing, the first lower housing having a cavity formed therein;
an adjustment assembly coupling the first lower housing to the second lower housing and coupling the first and second lower housings to the upper housing, the adjustment assembly is configured to adjust the relative positions of the first lower housing and the second lower housing relative to each other and relative to the upper housing; and
an induction sealing coil looping through the cavity of the upper housing and through the cavity of the first and second lower housings, the induction sealing coil being electrically connected to the conductive contacts on the upper housing.

2. The adjustable sealing head of claim 1, wherein the adjustment assembly comprises a rod attached to the upper housing, and at least one adjustment screw rotatably attached to, but linearly non-translatable relative to, the rod and rotatably attached to the first and second rail assemblies and to the rod.

3. The adjustable sealing head of claim 2, wherein a pair of adjustment screws are provided.

4. The adjustable sealing head of claim 1, wherein the at least one adjustment screw is rotated manually.

5. The adjustable sealing head of claim 2, wherein the at least one adjustment screw is rotated by a motor.

6. The adjustable sealing head of claim 2, wherein the at least one adjustment screw is formed of two parts which are rotatable relative to each other.

7. The adjustable sealing head of claim 2, wherein the at least one adjustment screw has left hand threads and right hand threads.

8. The adjustable sealing head of claim 2, wherein the adjustment assembly further comprises a plurality of slide pins coupling the first rail assembly and the second rail assembly to the mounting bar.

9. The adjustable sealing head of claim 1, wherein the adjustment assembly is actuated manually.

10. The adjustable sealing head of claim 1, wherein the adjustment assembly is driven by a motor.

11. The adjustable sealing head of claim 1, wherein each rail assembly is formed from a rail and a cover attached therein, the rail and cover forming a passageway and a cavity therein in which a portion of the induction sealing coil is seated.

12. The adjustable sealing head of claim 11, wherein the rail and the cover are formed of plastic.

13. The adjustable sealing head of claim 11, wherein each rail has an inner surface which faces each other and has a shape which corresponds to a shape of an associated container.

14. The adjustable sealing head of claim 1, in combination with a conveyor.
